(19) United States
(12) Patent Application Publication
(10) Pub. No.: US 2026/0241684 A1
(43) Pub. Date: Aug. 20, 2026

(54) INKJET HEAD DRIVING METHOD AND INKJET RECORDING APPARATUS

(71) Applicant: KONICA MINOLTA, INC., Tokyo (JP)

(72) Inventors: Yota Sasaki, Hachioji-shi, Tokyo (JP); Masanori Shimazoe, Hino-shi, Tokyo (JP)

(73) Assignee: KONICA MINOLTA, INC., Tokyo (JP)

(21) Appl. No.: 19/156,177

(22) PCT Filed: Nov. 14, 2023
(86) PCT No.: PCT/JP2023/040926

§ 371 Date: Aug. 13, 2025

(30) Foreign Application Priority Data
Feb. 14, 2023 (JP) 2023-020475

(51) Int. Cl. B41J 2/045; B41J 2/14; B41J 2/18; C09D 11/36

(52) U.S. Cl. CPC B41J 2/04588; B41J 2/04581; B41J 2/14233; B41J 2/1433; B41J 2/18; C09D 11/36; B41J 2002/14475

(57) ABSTRACT

An inkjet head driving method for an inkjet head includes, applying, to the piezoelectric element, the voltage signal of a composite drive waveform including unit drive waveforms to eject ink droplets landing on a recording medium in a combined state. The composite drive waveform includes at least four pulse waveforms within 4 AL from a start of applying the first pulse waveform. The composite drive waveform includes a first unit drive waveform and a second unit drive waveform that is applied at the end of the composite drive waveform and that causes the ink droplet to be ejected at a higher speed than the first unit drive waveform. The ink contains an alcohol having a carbon number of 1 or more and 4 or less in a range of 20% by mass or more and 50% by mass or less relative to an entirety of the ink.

### TECHNICAL FIELD

The present invention relates to an inkjet head driving method and an inkjet recording apparatus.

### BACKGROUND ART

In the related art, there is an inkjet recording apparatus which forms an image by ejecting ink from a nozzle provided in an inkjet head and landing the ink on a desired position. The inkjet head includes a pressure chamber that communicates with the nozzle, and a piezoelectric element that deforms in response to application of a voltage and applies a pressure change to the ink in the pressure chamber. When a predetermined drive signal is applied to the piezoelectric element, the ink is ejected from the nozzle in accordance with a change in the pressure of the ink in the pressure chamber.

For example, Patent Document 1 discloses a technique in which a plurality of ink droplets are ejected from a nozzle in accordance with each of a plurality of drive signals, and the plurality of ink droplets are combined and land on a recording medium.

### CITATION LIST

### Patent Literature

Patent Document 1: Japanese Unexamined Patent Application Publication No. 2007-144659

### SUMMARY OF INVENTION

### Technical Problem

However, when a quick-drying ink containing a highly volatile solvent is used, the ink dries in the nozzle and viscosity is likely to increase. For this reason, meniscus of the ink becomes unstable, or at least a part of an opening of the nozzle is blocked by the solidified ink. As a result, a flying direction and speed of each discharged droplet are likely to deviate from a desired mode. As a result, the plurality of droplets are more likely to land on a recording medium in a separation state without combining. Therefore, there is a problem in that image quality tends to deteriorate.

An object of the present invention is to provide an inkjet head driving method and an inkjet recording apparatus which can effectively suppress deterioration in image quality.

### Solution to Problem

In order to achieve the above object, the invention of an inkjet head driving method according to aspect 1 is an inkjet head driving method used in an inkjet head configured to be capable of ejecting ink droplets from a nozzle in which change in pressure is applied to ink in a pressure chamber by deforming a piezoelectric element according to an application of a voltage signal of a unit drive waveform including one or more pulse waveforms, the inkjet head driving method including:
applying, to the piezoelectric element, the voltage signal of a composite drive waveform including a plurality of the unit drive waveforms to eject from the nozzle a plurality of the ink droplets landing on a recording medium in a combined state,
wherein,
the composite drive waveform includes at least four pulse waveforms within 4 AL from a start of applying the first pulse waveform,
the composite drive waveform includes a first unit drive waveform and a second unit drive waveform that is applied at the end of the composite drive waveform and that causes the ink droplet to be ejected at a higher speed than the first unit drive waveform, and
the ink contains an alcohol having a carbon number of 1 or more and 4 or less in a range of 20% by mass or more and 50% by mass or less relative to an entirety of the ink.

The invention described in aspect 2 provides the inkjet head driving method according to aspect 1, wherein the ink contains the alcohol within a range of 20% by mass or more and 35% by mass or less relative to the entirety of the ink.

The invention described in aspect 3 provides the inkjet head driving method according to aspect 1, wherein the ink has a viscosity of 6 cP or less at the time of being ejected from the nozzle.

The invention described in aspect 4 provides the inkjet head driving method according to aspect 1, wherein a maximum width of an opening of the nozzle is 23 μm or less.

The invention described in aspect 5 provides the inkjet head driving method according to aspect 1, wherein,
the inkjet head includes a nozzle substrate including the nozzle,
the nozzle includes a tapered part which penetrates the nozzle substrate and in which an opening area in a cross section orthogonal to an ink ejection direction gradually increases from an opening side from which the ink droplet is ejected toward a side opposite to the opening, and
in a cross section that passes a center of the opening and is parallel to the ejection direction, a maximum value of an inclination angle of a surface of the tapered part from the ejection direction is 40° or more.

The invention described in aspect 6 provides the inkjet head driving method according to aspect 1, wherein a voltage signal of a vibration waveform for vibrating a liquid surface of the ink in the nozzle is applied to the piezoelectric element in a period in which the ink droplet is not discharged from the nozzle.

The invention described in aspect 7 provides the inkjet head driving method according to aspect 1, wherein the composite drive waveform is applied to the piezoelectric element at a frequency greater than or equal to 10 kHz.

The invention described in aspect 8 provides the inkjet head driving method according to aspect 1, wherein a voltage amplitude of a pulse waveform included in the second unit drive waveform is set to a magnitude with which the plurality of ink droplets are combined within 35 microseconds after the end of the application of the second unit drive waveform.

The invention described in aspect 9 provides the inkjet head driving method according to aspect 1, wherein
by varying the number of the unit drive waveforms included in the composite drive waveform, a droplet amount of the ink after combining can be adjusted to any one of a plurality of different droplet amounts, and
a minimum droplet amount among the plurality of the droplet amounts is 5 pl or less.

The invention described in aspect 10 provides the inkjet head driving method according to aspect 1, wherein
the inkjet head is connected to a circulation channel that passes the inkjet head, and
the ink that is not ejected from the nozzle during the ejection of the ink by the composite drive waveform is circulated in the circulation channel.

Furthermore, in order to achieve the above object, the invention of an inkjet recording apparatus according to aspect 11 includes,
an inkjet head configured to be capable of ejecting ink droplets from a nozzle in which change in pressure is applied to ink in a pressure chamber by deforming a piezoelectric element according to an application of a voltage signal of a unit drive waveform including one or more pulse waveforms; and
a drive controller that controls a voltage signal applied to the piezoelectric element,
wherein,
the drive controller applies to the piezoelectric element, a voltage signal of a composite drive waveform including a plurality of the unit drive waveforms to eject from the nozzle a plurality of the ink droplets landing on a recording medium in a combined state,
the composite drive waveform includes at least four pulse waveforms within 4 AL from a start of applying the first pulse waveform,
the composite drive waveform includes a first unit drive waveform and a second unit drive waveform that is applied at the end of the composite drive waveform and that causes the ink droplet to be ejected at a higher speed than the first unit drive waveform, and
the ink contains an alcohol having a carbon number of 1 or more and 4 or less in a range of 20% by mass or more and 50% by mass or less relative to an entirety of the ink.

### Advantageous Effects of Invention

According to the present invention, a decrease in image quality can be effectively suppressed.

### BRIEF DESCRIPTION OF DRAWINGS

FIG. 1 This is a diagram illustrating a schematic configuration of an inkjet recording apparatus.

FIG. 2 This is a schematic diagram illustrating a configuration of a head unit.

FIG. 3 This is a cross-sectional view illustrating an ink ejection mechanism of an inkjet head.

FIG. 4 This is a cross-sectional view of a nozzle substrate, showing a cross-section passing through a center of an opening of a nozzle and perpendicular to an X direction.

FIG. 5 This is a block diagram illustrating a functional configuration of the inkjet recording apparatus.

FIG. 6 This is a diagram illustrating a composite drive waveform for ink ejection in the inkjet recording apparatus.

FIG. 7 This is a diagram illustrating the composite drive waveform when a medium droplet is ejected.

FIG. 8 This is a diagram illustrating the composite drive waveform when a small droplet is ejected.

FIG. 9 This is an enlarged view of a repetitive waveform.

FIG. 10 This is a diagram illustrating a behavior of the ink ejected by a first unit drive waveform.

FIG. 11 This is an enlarged view of a termination waveform.

FIG. 12 This shows contents and results of an experiment.

FIG. 13 This is a diagram illustrating an ink circulation channel in a head unit according to modification example 4.

### DESCRIPTION OF EMBODIMENTS

Embodiments of a method for driving an inkjet head and an inkjet recording apparatus of the present invention will be described below with reference to the accompanying drawings.

### Configuration of Inkjet Recording Apparatus

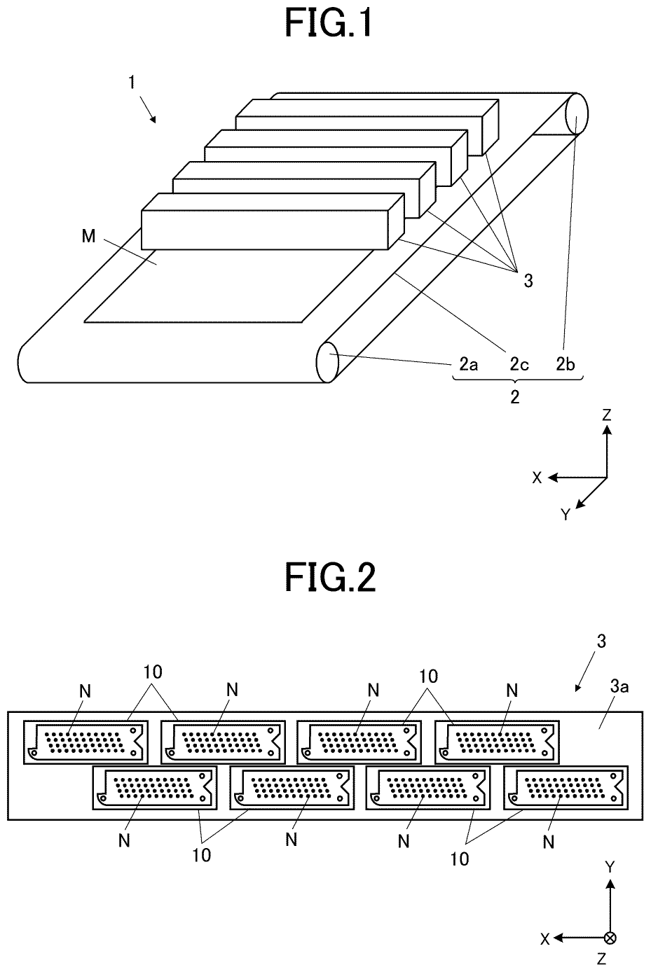

FIG. 1 is a schematic configuration of an inkjet recording apparatus 1 according to an embodiment of the present invention.

The inkjet recording apparatus 1 includes a conveyance section 2 and a head unit 3.

The conveyance section 2 includes two conveyance rollers 2a, 2b, and a ring-shaped conveyance belt 2c. The conveyance roller 2a and 2b rotate around rotation shafts extending in an X direction of FIG. 1. An inner side of the conveyance belt 2c is supported by two conveyance rollers 2a and 2b. The conveyance belt 2c circulates around the conveyance rollers 2a and 2b as the conveyance roller 2a rotates according to operation of a conveyance motor (not illustrated). The conveyance section 2 conveys a recording medium M in a movement direction of the conveyance belt 2c as the conveyance belt 2c circulates with the recording medium M placed on a conveyance surface of the conveyance belt 2c. Therefore, the movement direction of the conveyance belt 2c is the conveyance direction of the recording medium M. The conveyance direction is parallel to the Y direction in FIG. 1.

Note that the configuration of the conveyance section 2 is not limited to that illustrated in FIG. 1.

For example, the conveyance section 2 may include a stage that reciprocates in the Y direction in a state where the recording medium M is placed thereon.

Alternatively, the conveyance section 2 may include a rotating cylindrical conveyance drum. The conveyance section 2 moves the recording medium M placed on a cylindrical surface of the conveyance drum as the conveyance drum rotates.

The recording medium M is, for example, a flat cut sheet cut into a certain size. The recording medium M is supplied onto the conveyance belt 2c by a sheet feed device (not shown). An image is recorded on the recording medium M by ink being ejected from the head unit 3 onto the recording medium M. Thereafter, the recording medium M is ejected from the conveyance belt 2c to a predetermined sheet ejection section. Note that a roll sheet may be used as the recording medium M. Material of the recording medium M is not particularly limited as long as the ink landed on a surface can be fixed. For example, the recording medium M may be paper such as plain paper or coated paper, textile, sheet-shaped resin, or the like.

The head unit 3 ejects ink onto the recording medium M conveyed by the conveyance section 2 at appropriate timings based on image data. With this, the head unit 3 records the image on the recording medium M. The inkjet recording apparatus 1 according to the present embodiment includes four head units 3 respectively corresponding to ink in four colors, which are yellow (Y), magenta (M), cyan (C), and black (K). Four head units 3 are arranged in order of the colors Y, M, C, and K from an upstream side in a conveyance direction of the recording medium M. In addition, the head unit 3 is disposed such that an ink ejection direction is downward in a vertical direction. In FIG. 1, a −Z direction corresponds to the vertically downward direction. The number of the head units 3 may be three or less or five or more.

FIG. 2 is a schematic diagram illustrating the configuration of the head unit 3. Specifically, FIG. 2 is a plan view of the head unit 3 as viewed from the side facing the conveyance surface of the conveyance belt 2c.

The head unit 3 includes a plate-shaped support portion 3a and a plurality of inkjet heads 10. The plurality of inkjet heads 10 are fixed to the support portion 3a in a state of being fitted into a through hole of the support portion 3a. The head unit 3 according to the present embodiment includes eight inkjet heads 10. The inkjet head 10 is fixed to the support portion 3a in a state where an ink ejection face is exposed toward the side of the conveyance belt 2c from the through hole of the support portion 3a. The ink ejection face of the inkjet head 10 includes openings of the nozzles N.

The plurality of nozzles N included in the inkjet head 10 are arranged at equal intervals in the X direction. According to the present embodiment, each inkjet head 10 includes four nozzle rows. Each nozzle row includes nozzles N arranged one dimensionally at equal intervals in the X direction. Four nozzle rows included in the inkjet head 10 are arranged such that the positions of the nozzles N in the X direction are shifted from each other so that the positions of the nozzles N in the X direction do not overlap each other. The number of nozzle rows included in the inkjet head 10 is not limited to four, and may be three or less or five or more.

In the head unit 3, the eight inkjet heads 10 are arranged in a staggered manner such that an arrangement range of the nozzles N in the X direction is continuous. The arrangement range of the nozzles N included in the head unit 3 in the X direction covers a width in the X direction in a region in which the image can be recorded on the recording medium M. The head unit 3 is used in a fixed position during formation of the image. The head unit 3 forms the image by a single-pass method by ejecting ink from the nozzle N to each position at a predetermined interval in the conveyance direction according to the conveyance of the recording medium M.

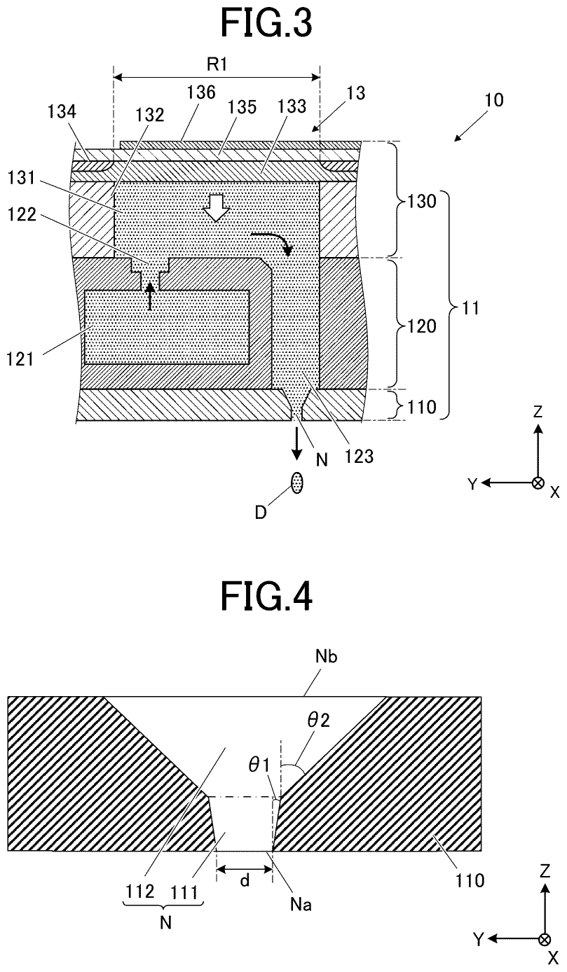

FIG. 3 is a cross-sectional view illustrating an ink ejection mechanism of the inkjet head 10.

The inkjet head 10 includes a head chip 11 including a mechanism for ejecting ink from the nozzle N. Hereinafter, the +Z direction is also referred to as upward, and the −Z direction is also referred to as downward. The head chip 11 includes a nozzle substrate 110 including the nozzle N, a channel substrate 120 including a channel communicating with the nozzle N, and an element substrate 130 including a piezoelectric element 13 and the like. The nozzle substrate 110, the channel substrate 120, and the element substrate 130 are stacked in this order. The nozzle substrate 110 and the channel substrate 120 are bonded together with an adhesive or the like. The channel substrate 120 and the element substrate 130 are bonded to each other with an adhesive or the like.

The nozzle substrate 110 includes a plurality of nozzles N. The material of the nozzle substrate 110 is not particularly limited. For example, the material of the nozzle substrate 110 may be silicon.

FIG. 4 is a diagram illustrating a cross section of the nozzle substrate 110. This is a cross section passing through the center of the opening Na of the nozzle N and perpendicular to the X direction.

The nozzle N penetrates through the nozzle substrate 110. An end portion of the nozzle N on the −Z direction side is an opening Na from which droplets of the ink are discharged. The end portion of the nozzle N on the +Z direction side is a connection section Nb to be connected to a through channel 123 of the channel substrate 120 described later. According to the present embodiment, the opening Na has a circular shape. The connection section Nb is a circular opening. The nozzle N includes a first nozzle channel 111 and a second nozzle channel 112. The first nozzle channel 111 and the second nozzle channel 112 communicate with each other in the Z direction. The first nozzle channel 111 extends in the +Z direction from the opening Na. The second nozzle channel 112 extends in the +Z direction from the end portion of the first nozzle channel 111 on the +Z direction side to the connection section Nb. The first nozzle channel 111 and the second nozzle channel 112 are tapered parts whose inner wall surfaces are inclined from the ejection direction in a cross section that passes through the center of the opening Na and that is parallel to the ejection direction of the ink. Specifically, in the first nozzle channel 111 and the second nozzle channel 112, an opening area in a cross section orthogonal to the ejection direction gradually increases from the opening Na side toward the connection section Nb side. Therefore, a diameter d of the opening Na is smaller than the diameter of the connection section Nb. The diameter d of the opening Na is preferably 23 μm or less. The diameter d of the opening Na corresponds to a maximum width of the opening Na.

In the cross section of FIG. 4, an inclination angle of the inner wall surface of the first nozzle channel 111 from the ejection direction is defined as θ1. An inclination angle of the inner wall surface of the second nozzle channel 112 from the ejection direction is defined as θ2. The inclination angles θ1 and θ2 satisfy θ1<θ2. The inclination angle θ2 is preferably greater than or equal to 40°. In a case in which the inclination angle θ2 is not constant, it is preferable that the maximum value of the inclination angle of the inner wall surface of the second nozzle channel 112 is 40° or more. According to the present embodiment, the inclination angle θ2 is 50°.

According to the present embodiment, the inclination angle θ1 is 9°. Note that the inclination angle θ1 may be 0°. That is, the first nozzle channel 111 may have a straight shape parallel to the Z direction.

Referring back to FIG. 3, various channels through which ink to be supplied to the nozzle N passes are provided in the channel substrate 120 and the element substrate 130. Specifically, the channel substrate 120 is provided with a through channel 123 that communicates with the nozzle N and penetrates the channel substrate 120 in the Z direction. In addition, a pressure chamber 131 which communicates with the through channel 123 is provided in the element substrate 130. In addition, a communication channel 122 and a common channel 121 which communicates with the pressure chamber 131 via the communication channel 122 are provided in the channel substrate 120. The through channel 123, the pressure chamber 131, and the communication channel 122 are provided for each nozzle N. The common channel 121 communicates with the plurality of nozzles N forming a nozzle row. In addition, the common channel 121 extends in the X direction over the arrangement range of the plurality of nozzles N forming the nozzle row. The ink supplied to the common channel 121 is supplied to the plurality of nozzles N via the pressure chambers 131 and the through channels 123 corresponding to the respective nozzles N.

The channel substrate 120 is formed of, for example, a plurality of laminated plate-like members. The plurality of plate-like members include openings at the positions of the common channel 121, the communication channel 122, and the through channel 123. As the plate-like member, for example, a metal such as SUS (stainless steel material) can be used. Note that the channel substrate 120 may be formed by processing a substrate of silicon or the like.

The element substrate 130 includes a pressure chamber layer 132 in which the pressure chamber 131 is formed. Furthermore, the element substrate 130 includes a vibration plate 133, an insulating layer 134, a piezoelectric material layer 135, and an electrode layer 136, which are stacked in this order on the upper part of the pressure chamber layer 132. A lower surface of the pressure chamber 131 is formed by the channel substrate 120 joined to the lower surface of the pressure chamber layer 132. An upper surface of the pressure chamber 131 is formed by the vibration plate 133. The vibration plate 133 is made of, for example, a metal material having conductivity. The vibration plate 133 also serves as a lower electrode of the piezoelectric material layer 135. The lower electrode is a common electrode facing the plurality of electrode layers 136. The vibration plate 133 is connected to a wiring of a reference potential via a wiring (not shown). The insulating layer 134 insulates the vibration plate 133 from the piezoelectric material layer 135. In detail, the insulating layer 134 blocks voltage application to the piezoelectric material layer 135 other than a piezoelectric functional region R1. The piezoelectric element 13 is formed of the portion of the piezoelectric material layer 135 corresponding to the piezoelectric functional region R1.

As the piezoelectric material layer 135, PZT (lead zirconate titanate) is suitable. However, as the piezoelectric material layer 135, another material having piezoelectric characteristics, for example, quartz, lithium niobate, barium titanate, lead titanate, lead metaniobate, polyvinylidene fluoride, or the like may be used. As the electrode layer 136, for example, titanium containing a noble metal may be used.

Each of the pressure chamber layer 132, the vibration plate 133, the insulating layer 134, the piezoelectric material layer 135, and the electrode layer 136 does not necessarily have to be a single layer and may have a plurality of layers. In addition, another layer may be further disposed between any of the layers among the pressure chamber layer 132, the vibration plate 133, the insulating layer 134, the piezoelectric material layer 135, and the electrode layer 136.

In the head chip 11 having such a configuration, a voltage signal of a drive waveform for driving the piezoelectric element 13 is supplied to the electrode layer 136. According to the present specification, the voltage signal of the drive waveform is also referred to as a “drive signal”. The piezoelectric element 13 is deformed to bend in the Z direction in accordance with the voltage applied between the electrode layer 136 to which the drive signal has been supplied and the vibration plate 133 at the reference potential. The vibration plate 133 is deformed according to the deformation of the piezoelectric element 13. When the vibration plate 133 is deformed, a pressure change corresponding to a deformation amount is generated in the ink in the pressure chamber 131. In accordance with the pressure change of the ink in the pressure chamber 131, the ink is pushed out from the pressure chamber 131 to the nozzle N or the ink is pulled back from the nozzle N or the like.

According to the present embodiment, when the electrode layer 136 is set to a potential that is more negative than the reference potential, the piezoelectric element 13 is deformed into a shape that expands the pressure chamber 131, that is, a shape that is convex upward in FIG. 3. In addition, when the electrode layer 136 is set to a potential more positive than the reference potential, the piezoelectric element 13 is deformed into a shape that causes the pressure chamber 131 to contract, that is, a shape that is convex downward in FIG. 3. For example, when the piezoelectric element 13 is deformed into an upwardly convex shape to expand the pressure chamber 131, and then the piezoelectric element 13 is returned to the original shape, pressure is applied to the ink, and the ink is ejected from the nozzle N. The waveform of a drive signal to be applied to the electrode layer 136 will be described in detail later.

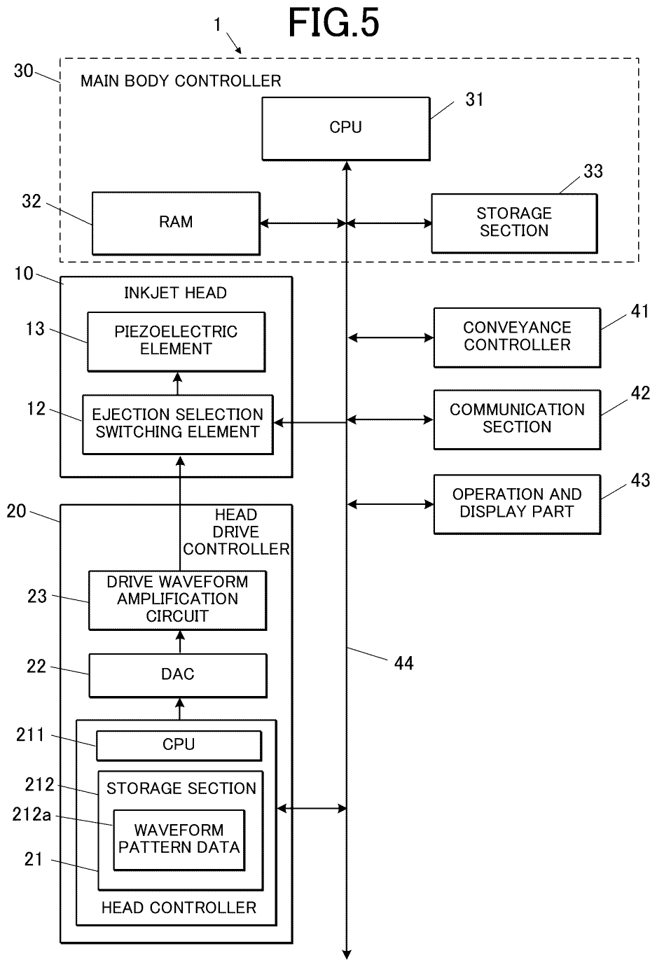

FIG. 5 is a block diagram illustrating a functional configuration of the inkjet recording apparatus 1.

The inkjet recording apparatus 1 includes a main body controller 30, the inkjet head 10, a head drive controller 20 as a “drive controller”, a conveyance controller 41, a communication section 42, and an operation and display part 43. Each unit of the inkjet recording apparatus 1 is connected via a bus 44 so as to be able to transmit and receive signals.

The main body controller 30 comprehensively controls the overall operation of the inkjet recording apparatus 1. The main body controller 30 includes a central processing unit (CPU 31), a random access memory (RAM 32), and a storage section 33.

The CPU 31 performs various kinds of arithmetic processing. The CPU 31 reads the control program stored in the storage section 33 and performs various kinds of control processing related to image recording, its setting, and the like.

The RAM 32 provides a working memory space for the CPU 31 and stores temporary data. The storage section 33 includes a nonvolatile memory that stores a control program, setting data, and the like. Furthermore, the storage section 33 may include a DRAM or the like that temporarily stores settings related to a print job acquired from the outside via the communication section 42, image data to be recorded, and the like.

The inkjet head 10 includes the above-described head chip 11 including the piezoelectric element 13, and an ejection selection switching element 12 electrically connected to the electrode layer 136 of the head chip 11.

The ejection selection switching element 12 switches the signal to be supplied to each piezoelectric element 13. The signal supplied to each piezoelectric element 13 includes a drive signal for ink ejection and a drive signal for ink non-ejection. In other words, the ejection selection switching element 12 supplies to the piezoelectric element 13 the drive signal according to whether to eject or not eject the ink from the nozzle N corresponding to the piezoelectric element 13 based on the image data of the image to be recorded or the like. Thus, the variation pattern of the pressure applied to the ink in each of the nozzles N can be switched. The drive signal for non-ejection of ink is a voltage signal having a waveform with a small amplitude (vibration waveform) that vibrates a meniscus of the ink in the nozzle N to the extent that the ink is not ejected. Here, the meniscus of the ink is a liquid surface or an interface of the ink in the nozzle N.

The head drive controller 20 outputs the drive signal to drive the piezoelectric element 13 of the inkjet head 10 at appropriate timings according to pixel data of the image to be recorded. The head drive controller 20 may be collectively disposed on the substrate or the like, or may be dispersedly disposed in respective sections of the inkjet recording apparatus 1. In addition, some or all of the components of the head drive controller 20 may be disposed in the inkjet head 10. The head drive controller 20 includes a head controller 21, a digital-analog converter (DAC 22), and a drive waveform amplification circuit 23.

The head controller 21 controls the operation of the head drive controller 20 in accordance with the presence or absence of the image data to be recorded and the content of the image data. The head controller 21 includes a CPU 211 and a storage section 212. The storage section 212 stores waveform pattern data 212a including information of a drive waveform pattern for ejecting ink from the nozzle N or vibrating the meniscus. In the waveform pattern data 212a, the drive waveform pattern is stored as digital discrete value array data. As the storage section 212, a nonvolatile memory such as a ROM or a rewritable and updatable flash memory is used.

The CPU 211 selects an appropriate waveform pattern based on the image data that is to be recorded stored in the storage section 212 or the storage section 33, and outputs the data of the selected waveform pattern. The waveform pattern is selected so that the head drive controller 20 outputs a drive signal having an appropriate waveform pattern according to, for example, whether or not to cause the ink to be ejected from each of the nozzles N. The CPU 211 outputs the waveform pattern data at an appropriate timing corresponding to a clock signal (not illustrated). The head controller 21 may be provided in common with the main body controller 30.

The DAC 22 converts, into analog, the waveform pattern data of each drive waveform outputted at predetermined clock frequencies from the head controller 21. Furthermore, the DAC 22 outputs the obtained analog signal to the drive waveform amplification circuit 23.

The drive waveform amplification circuit 23 amplifies the signal input from the DAC 22 and outputs the amplified drive signal to each of the piezoelectric elements 13. The amplification operation includes, for example, voltage amplification and current amplification. Thus, the drive signal including a trapezoidal voltage waveform that changes to each of a positive side and a negative side with respect to the reference potential is applied to the piezoelectric element 13.

The conveyance controller 41 operates the motor that rotates the conveyance roller 2a to rotate the conveyance roller 2a. Accordingly, the conveyance controller 41 moves the recording medium M at an appropriate timing and speed by the conveyance belt 2c. The conveyance controller 41 may have the same configuration as the main body controller 30.

The communication section 42 transmits and receives data to and from an external device in accordance with a predetermined communication standard. The communication section 42 includes, for example, a connection terminal according to a communication standard to be used and hardware of a driver related to communication connection, for example, a network card.

The operation and display part 43 displays status information, a menu, and the like related to image recording. Further, the operation and display part 43 receives an input operation from the user. The operation and display part 43 includes, for example, a display screen formed of a liquid crystal panel, a driver for the liquid crystal panel, and a touch screen overlaid on the liquid crystal screen. The operation and display part 43 outputs, to the main body controller 30, the operation detection signal corresponding to a position at which a touch operation is performed by the user and a type of the operation.

### Quick-Drying Ink

The inkjet recording apparatus 1 according to the present embodiment discharges the ink including quick-drying properties from the nozzle N. Hereinafter, the ink including the quick-drying properties is referred to as “quick-drying ink”.

The quick-drying ink used in the present embodiment contains a solvent and other components to be dissolved or dispersed in the solvent. Here, the other components include a coloring agent, and may further include a surfactant or the like. As the coloring agent, a known pigment or dye is used.

The solvent contains an alcohol having a carbon number of 1 or more and 4 or less. In addition, the amount of the solvent and the proportion of the alcohol in the solvent are adjusted such that the alcohol having the carbon number of 1 or more and 4 or less is contained in a range of 20% by mass or more and 50% by mass or less with respect to the entire ink.

As the alcohol having the carbon number 1 or more and 4 or less, for example, methanol (methyl alcohol: carbon number 1), ethanol (ethyl alcohol: carbon number 2), 1-propanol (propyl alcohol: carbon number 3), 2-propanol (isopropyl alcohol: carbon number 3), 1-butanol (butyl alcohol: carbon number 4), 2-butanol (sec-butyl alcohol: carbon number 4), or the like can be used. Since these alcohols having the carbon number of 1 or more and 4 or less have a lower boiling point and higher volatility than the other alcohols, the quick-drying properties of the ink after landing on the recording medium M can be effectively enhanced. Specifically, by setting the ratio of the alcohol having the carbon number of 1 or more and 4 or less with respect to the entire ink to 20% by mass or more, it is possible to secure the quick-drying properties required for practical use. Further, by setting the ratio of the alcohol having the carbon number of 1 or more and 4 or less with respect to the entire ink to 50% by mass or less, it is possible to sufficiently suppress the occurrence of a problem due to drying of the ink in the nozzle N, which will be described later. The solvent of the quick-drying ink is preferably composed of only the alcohol including the carbon number of 1 or more and 4 or less. In this case, two or more kinds of alcohols including the carbon number of 1 or more and 4 or less may be used in combination. The alcohol including the carbon number of 1 or more and 4 or less and another alcohol may be used in combination.

The alcohol including the carbon number of 1 or more and 3 or less may be adjusted to be contained in a range of 20% by mass or more to 50% by mass or less respect to the entire ink. Thus, the quick-drying properties can be further enhanced.

The solvent may contain water.

The quick-drying ink according to the present embodiment is adjusted to include a viscosity of 6 cP or less at the time of being ejected from the nozzle N. In order to realize such viscosity, the inkjet recording apparatus 1 may include a heating section for heating the ink to reduce the viscosity.

In addition, the quick-drying ink of the present embodiment is adjusted such that surface tension at the time of being discharged from the nozzle N is 25 mN/m or less.

The quick-drying ink used in the present embodiment dries in a short time of about several hundred milliseconds to several seconds after landing on the recording medium M. In the related art, particularly, in a case in which printing is performed on a surface of a non-absorbent recording medium M such as a plastic film, coated sheet, or laminated paper, it is general to dry ink after printing by blowing or heating the ink. In contrast, by using the quick-drying ink of the present embodiment, it is possible to simplify or omit the drying step.

On the other hand, the quick-drying ink tends to dry also in the nozzle N. For this reason, the meniscus of the nozzle N is thickened due to drying and becomes unstable, or a phenomenon called “decap” is likely to occur. Here, the decap is a phenomenon in which the ink in the vicinity of the opening Na of the nozzle N is dried and thickened or solidified, and at least a part of the opening Na of the nozzle N is clogged. When destabilization or decap of the meniscus occurs, landing position misregistration occurs due to a decrease in the speed of the discharged droplet or an abnormality in the flying direction. In addition, in the case of adopting a multi-drop method in which a plurality of droplets are discharged and finally combined into one droplet, a decrease in the speed of the droplet or an abnormality in the flying direction leads to a problem in that the droplets are not appropriately combined. When the droplets land on the recording medium M in a state in which the droplets are not appropriately combined, a plurality of dots are formed by the ink which is supposed to form one dot, or the shape of the dot is disturbed. Therefore, the image quality deteriorates.

In contrast, in the method of driving the inkjet head 10 according to the present embodiment, the drive signal applied to the piezoelectric element 13 is adjusted to suppress the destabilization of the meniscus and the occurrence of decap, thereby reducing the likelihood of a reduction in image quality.

### Method of Driving Inkjet Head

Hereinafter, a method of driving the inkjet head 10 in the inkjet recording apparatus 1 according to the present embodiment will be described.

In the method of driving the inkjet head 10 of the present embodiment, a voltage signal of a composite drive waveform including a plurality of unit drive waveforms is used. Each unit drive waveform is a waveform for ejecting one ink droplet from the nozzle N. By supplying the voltage signal having the composite drive waveform to the electrode layer 136 and applying it to the piezoelectric element 13, a plurality of ink droplets can be ejected from the nozzle N. In addition, it is possible to land the plurality of discharged ink droplets on the recording medium M in a state of being combined. Hereinafter, applying the voltage signal having a drive waveform to the piezoelectric element 13 is also simply referred to as “applying a drive waveform”.

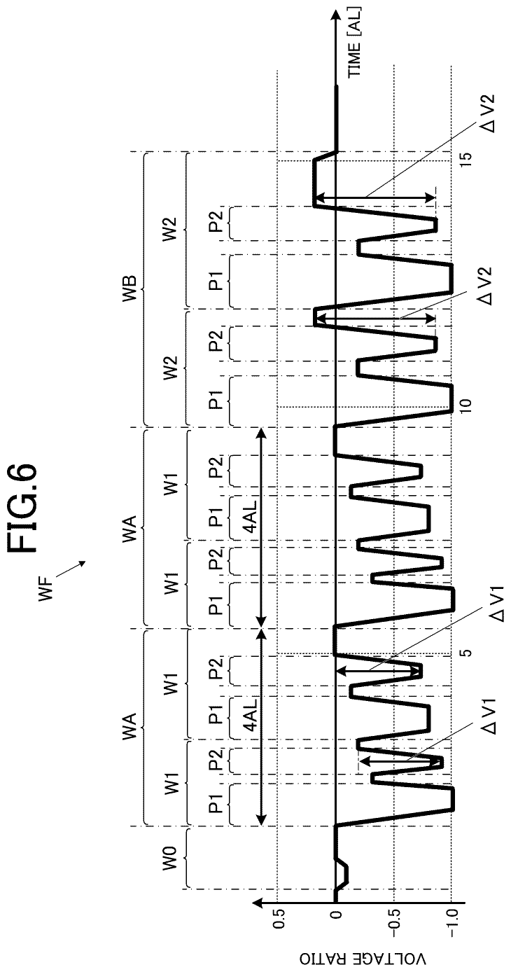

FIG. 6 is a diagram illustrating a composite drive waveform WF for ink ejection in the inkjet recording apparatus 1.

The vertical axis of FIG. 6 represents a potential ratio when the reference potential is set to 0 and a lowest potential on the negative side of the composite drive waveform WF is set to −1. The reference potential is a potential in a standby state in which an ink ejection operation is not performed.

The horizontal axis represents time. The unit of the horizontal axis is acoustic length (AL). AL is 1/2 of an acoustic resonance period of a pressure wave in the pressure chamber 131. The AL is usually about several microseconds.

The composite drive waveform WF in FIG. 6 includes a vibration waveform WO that causes the meniscus of the ink in the nozzle N to vibrate, four first unit drive waveforms W1 that each cause droplets of the ink to be ejected, and two second unit drive waveforms W2 that each cause droplets of the ink to be ejected. The second unit drive waveform W2 is applied after the four first unit drive waveforms W1. Hereinafter, any one of the first unit drive waveform W1 and the second unit drive waveform W2 is referred to as a “unit drive waveform Wn”. The composite drive waveform WF shown in FIG. 6 includes six unit drive waveforms Wn. Application of the composite drive waveform WF to the piezoelectric element 13 can cause the six ink droplets ejected from the nozzle N to be combined and land on the recording medium M. In the following description, the droplet obtained by combining six ink droplets in this manner is also referred to as a “large droplet”.

By vibrating the meniscus of the nozzle N by applying the vibration waveform WO before the application of the first unit drive waveform W1, it is possible to suppress fluctuations in the ejection characteristics of the ink due to drying and thickening of the meniscus of the ink. The period prior to the application of the initial first unit drive waveform W1 is one mode of a period during which ink droplets are not ejected from the nozzle.

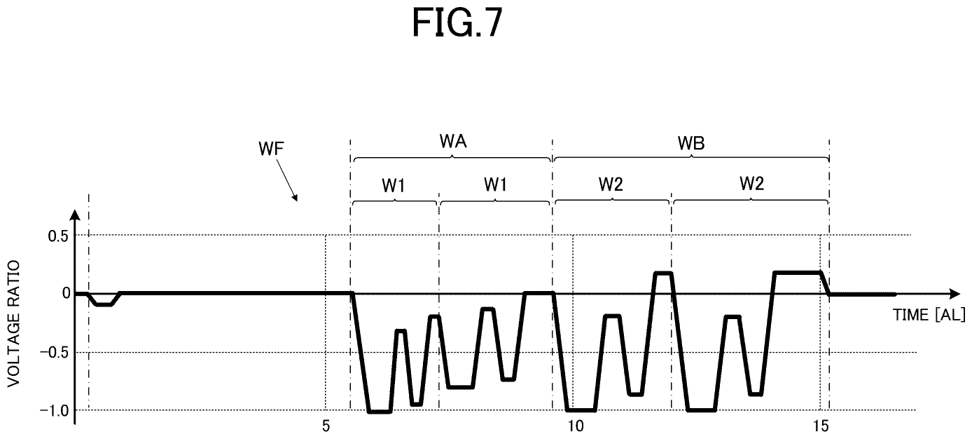

In addition, as shown in FIG. 7, by omitting the first two first unit drive waveforms W1, four droplets ejected by the remaining four unit drive waveforms can be combined and landed on the recording medium M. The ink obtained by combining the four ink droplets in this manner is a “medium droplet” having a smaller droplet amount than the “large droplet”.

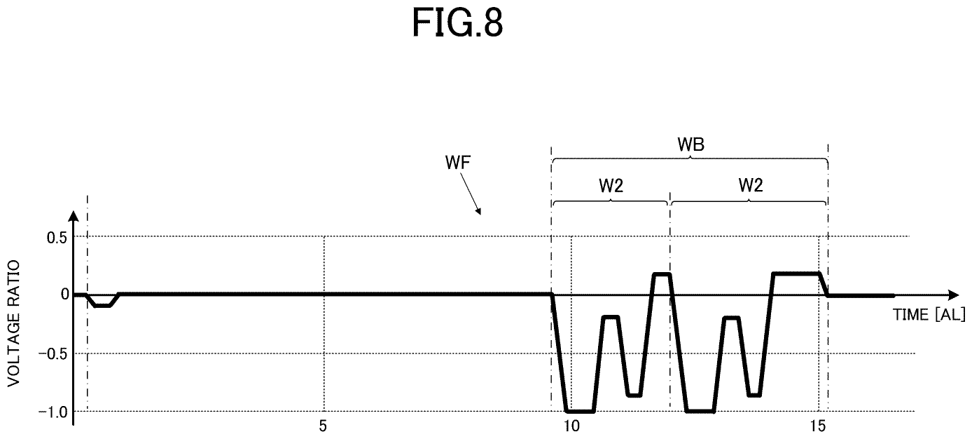

In addition, as shown in FIG. 8, by omitting the first four first unit drive waveforms W1, two droplets ejected by the remaining two second unit drive waveforms W2 can be combined and landed on the recording medium M. The ink formed by combining the two ink droplets in this manner is a “small droplet” having a smaller droplet amount than the “medium droplet”. The droplet amount of the small droplet is, for example, 5 pl or less.

In this way, by making the number of unit drive waveforms Wn included in the composite drive waveform WF different, the droplet amount of the ink after the combining can be adjusted to any one of a plurality of different droplet amounts.

The first two first unit drive waveforms W1 of the composite drive waveform WF of FIG. 6 form a repetitive waveform WA. Further, the third and fourth first unit drive waveforms W1 constitute the repetitive waveform WA in a similar manner. These two repetitive waveforms WA are the same.

The last two second unit drive waveforms W2 of the composite drive waveform WF constitute a termination waveform WB. Therefore, the last unit drive waveform in the composite drive waveform WF is the second unit drive waveform W2.

According to such composite drive waveform WF, the respective droplets of the ink ejected from the nozzle N can be brought into the combined state at the stage of being ejected. That is, six droplets are discharged from the nozzle N in a state of being connected in a columnar shape, and are landed on the recording medium M without being separated during flying. Alternatively, even in a case in which six droplets are ejected in a state of being connected in a column shape and then are separated in the middle, all of the droplets are combined into one before landing on the recording medium M.

The composite drive waveform WF is applied to the piezoelectric element 13 at frequencies equal to or higher than the 10 kHz. That is, the ink in which six droplets are combined can be repeatedly ejected in a cycle of 100 microseconds or less.

Hereinafter, the configurations and operations of the repetitive waveform WA and the termination waveform WB for enabling ink ejection in such a mode will be described.

### Repetitive Waveform WA

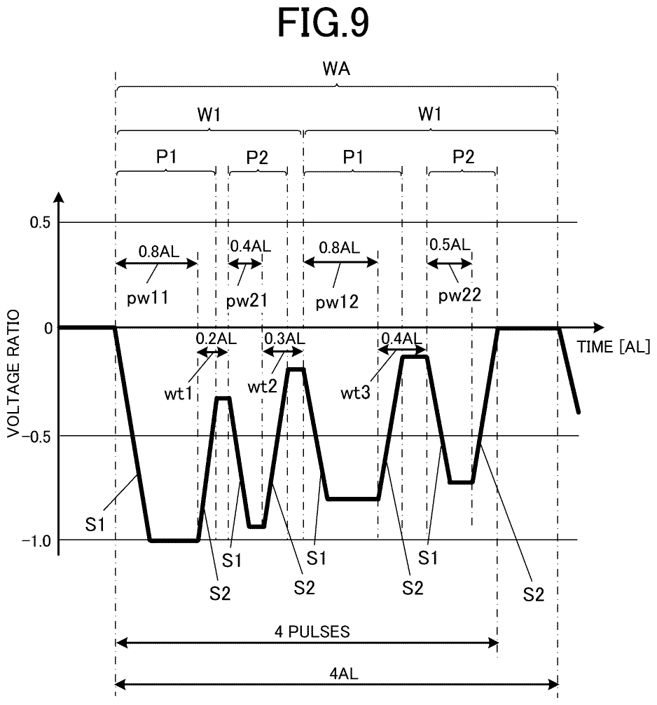

FIG. 9 is an enlarged view of the repetitive waveform WA.

Two first unit drive waveforms W1 included in the repetitive waveform WA each include a main pulse P1 and a pullback pulse P2. The main pulse P1 has a pulse waveform for causing the nozzle N to eject the ink droplet. The pullback pulse P2 includes a pulse waveform for applying, to the droplet of the ink ejected by the main pulse P1, force in a direction to be pulled back to the side opposite to the ejection direction. One ink droplet is ejected from the nozzle N by a combination of the main pulse P1 and the pullback pulse P2. The main pulse P1 corresponds to a “first pulse waveform” and the pullback pulse P2 corresponds to a “second pulse waveform”.

The main pulse P1 includes an inflation portion S1 in which the potential decreases, and a deflation portion S2 in which the potential increases after the inflation portion S1. A period from the time when the inflation portion S1 starts to the time when the inflation portion S1 ends is set as an application period of the main pulse P1. During a period corresponding to the inflation portion S1 of the main pulse P1, the piezoelectric element 13 changes such that the pressure chamber 131 expands. In the subsequent period corresponding to the deflation portion S2, the piezoelectric element 13 is changed so that the pressure chamber 131 is contracted in the direction of returning to an original shape. By performing such expansion and contraction of the pressure chamber 131 at timings when resonance of a pressure wave in the pressure chamber 131 occurs, the pressure is applied to the ink in the pressure chamber 131 and the ink is ejected from the nozzle N.

The length from the start timing of the inflation portion S1 to the start timing of the deflation portion S2 in the main pulse P1 is defined as the pulse width of the main pulse P1. The pulse width of the main pulse Pl is set within the range of 0.7 AL or more and 1 AL or less, more preferably 0.7 AL or more and 0.9 AL or less. According to the present embodiment, the pulse widths pw11 and pw12 of the main pulses P1 in the two first unit drive waveforms W1 are both 0.8 AL.

On the other hand, the pullback pulse P2 also includes an inflation portion S1 and a deflation portion S2, similarly to the main pulse P1. A period from the time when the inflation portion S1 starts to the time when the inflation portion S1 ends is set as an application period of the pullback pulse P2. The length from the start timing of the inflation portion S1 to the start timing of the deflation portion S2 in the pullback pulse P2 is defined as the pulse width of the pullback pulse P2. The pulse width of the pullback pulse P2 is set in the range of 0.3 AL or more and 0. 6 AL or less, and shorter than the pulse width of the pulse waveform of the main pulse P1. According to the present embodiment, the pulse width pw21 of the pullback pulse P2 in the first first unit drive waveform W1 is 0.4 AL. Further, the pulse width pw22 of the pullback pulse P2 in the second first unit drive waveform W1 is 0.5 AL.

A standby time wt1 between the pulse width pw11 and the pulse width pw21 is 0.2 AL. A standby time wt2 between the pulse width pw21 and the pulse width pw12 is 0.3 AL. A standby time wt3 between the pulse width pw12 and the pulse width pw22 is 0.4 AL.

By expanding the pressure chamber 131 by applying the inflation portion S1 of the pullback pulse P2 at the timing of suppressing a reverberation vibration due to the main pulse P1, it is possible to exert force on the droplet of the ink in the direction of pulling back the droplet of the ejected ink. Accordingly, it is possible to decelerate the droplet of the ink which is ejected by the main pulse P1.

Due to the influence of the main pulse P1, the meniscus recedes to the deep side of the nozzle N. Thereafter, by applying the pullback pulse P2, the force in the pullback direction is applied to the ejected ink droplet, and the retracted meniscus can be advanced in the direction of the opening Na of the nozzle N. Moving the meniscus forward in this manner can increase the amount of an ink droplet to be ejected by the next unit drive waveform Wn. In addition, the speed of the droplet can be suppressed in accordance with an increase in the droplet amount. Due to the advance of the meniscus, the position of the meniscus becomes close to a steady position.

Therefore, even in a case in which the ink is ejected at a high frequency, it is possible to stably eject the droplet at a desired amount and speed.

The potential of the repetitive waveform WA changes within a range equal to or lower than the reference potential. In detail, the first main pulse P1 of the repetitive waveform WA starts from the reference potential and decreases to a voltage ratio of −1.0 at the end of the inflation portion S1. Further, an absolute value of the lowest potential of the four pulse waveforms included in the repetitive waveform WA becomes smaller and closer to the reference potential as the pulse waveform is applied later. Here, the lowest potential of each pulse waveform is the potential at the end of the inflation portion S1. Further, the potentials at the end of the application of the four pulse waveforms included in the repetitive waveform WA become smaller in absolute value and closer to the reference potential as the pulse waveform is applied later. Here, the potential at the end of application of the pulse waveform is the potential at the end of the deflation portion S2. The potential at the end of the repetitive waveform WA returns to the reference potential. By returning to the reference potential, the same repetitive waveform WA can be easily repeatedly applied two or more times.

Due to such potential transition in the repetitive waveform WA, as illustrated in FIG. 6, in the first unit drive waveform W1, the voltage amplitude Δ V1 of the deflation portion S2 of the pullback pulse P2 is suppressed to be small. Thus, acceleration of the ink due to contraction of the pressure chamber 131 in accordance with the deflation portion P2 of the pullback pulse S2 is suppressed. As a result, the speed of the ink droplet ejected by the combination of the main pulse P1 and the pullback pulse P2 in the first unit drive waveform W1 can be made extremely low. The speed of the droplet of the ink ejected by the first unit drive waveform W1 is, for example, about 1 m/sec.

The waveform of the repetitive waveform WA is adjusted so that the length of the entire waveform is within a range of 3.5 AL or more and less than 4.5 AL, and more preferably close to 4 AL. In the present embodiment, the length of the repetitive waveform WA is 4 AL. Accordingly, the pressure wave in the nozzle N at the end of the repetitive waveform WA of the former stage accelerates the ink ejected by the repetitive waveform WA of the latter stage. For this reason, it is possible to suppress the occurrence of a problem in which the liquid droplet speed of the ink which is ejected by the subsequent repetitive waveform WA of the latter stage is too low and cannot be combined.

Note that as long as the length of the repetitive waveform WA satisfies the above-described conditions, the length of the first unit drive waveform W1 included in the repetitive waveform WA does not have to be equal.

Furthermore, the composite drive waveform WF preferably includes application periods of at least four pulse waveforms within 4 AL from the start of application of the first pulse waveform. In other words, it is preferable that the pulse waveform be applied at the beginning of the composite drive waveform WF at a frequency of one pulse or more per 1 AL on average in a period within the 4 AL from the start of the application of the first pulse waveform. Here, the pulse waveform applied within the 4 AL refers to the main pulse P1 or the pullback pulse P2, and does not include the vibration waveform W0. According to the present embodiment, as shown in FIG. 9, the first repetitive waveform WA of the composite drive waveform WF includes application periods of four pulse waveforms within 4 AL. By applying at least four pulse waveforms within the 4 AL, the meniscus of the nozzle N oscillates at a high oscillation number, and the ink in the nozzle N is stirred. Therefore, it is possible to effectively suppress destabilization and decap of the meniscus. As a result, it is possible to suppress bending of the droplet which is discharged first.

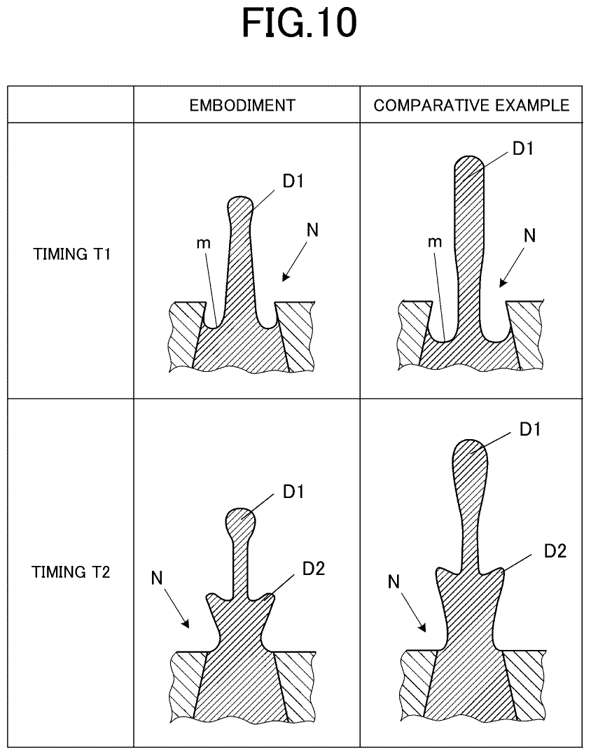

FIG. 10 is a diagram illustrating the behavior of the ink ejected by the first unit drive waveform W1.

The behavior of the ink ejected by the first unit drive waveform W1 of the present embodiment is illustrated on the left side of FIG. 10. On the right side of FIG. 10, the behavior of the ink ejected by the unit drive waveform of the comparative example is illustrated. The unit drive waveform of the comparative example is different from the first unit drive waveform W1 of the present embodiment in that it includes the main pulse P1 and does not include the pullback pulse P2.

In the upper part of FIG. 10, the state of the timing T1 at which the first ink droplet D1 is discharged from the nozzle N in response to the first unit drive waveform is illustrated.

According to the present embodiment, at the timing T1, the droplet D1 of the discharged ink is pulled back to the nozzle N side in response to the application of the pullback pulse P2. Therefore, the position of the droplet D1 is closer to the opening of the nozzle N than in the comparative example.

In addition, according to the present embodiment, a meniscus m advances in the ejection direction due to force being applied to the droplet D1 in the direction of pulling back toward the nozzle N. Thus, the position of the meniscus m of the present embodiment is closer to the opening of the nozzle N than the position of the meniscus m of the comparative example.

In the lower part of FIG. 10, the state of the timing T2 at which the second ink droplet D2 is discharged from the nozzle N in response to the main pulse P1 of the second unit drive waveform is illustrated.

According to the present embodiment, the speed of the droplet D2 discharged at the timing T2 is suppressed to be low. This is because, as a result of the meniscus m advancing by the pullback pulse P2 at the timing T1, the amount of the second droplet D2 increases, and the speed decreases accordingly. According to the present embodiment, since both of the droplets D1 and D2 are ejected at a low speed as described above, the droplets D1 and D2 are ejected from the nozzle N in a state where the droplets D1 and D2 are linked and combined together. Similarly, the ink ejected by the third and fourth first unit drive waveforms W1 also becomes low speed. For this reason, the droplets of the third and fourth inks are also discharged in a state where the droplets D1 and D2 discharged in the previous stage are joined and combined.

On the other hand, in the comparative example, the speed of the second ink droplet D2 is greater than that in the present embodiment, and the ink droplet D2 flies farther than that in the present embodiment at the time point of the timing T2. This is because the amount of the droplet D2 in the comparative example is smaller than that in the present embodiment, and the speed of the second droplet increases accordingly. The reason why the amount of the droplet D2 decreases is that the second ink droplet D2 is ejected in a state where the meniscus m is retracted due to no application of the pullback pulse P2. As described above, in the comparative example, both the droplets D1 and D2 fly at a higher speed than in the present embodiment. For this reason, although the droplets D1 and D2 are continuous at the stage of FIG. 10, the droplets D1 and D2 easily undergo separation with the passage of time, and the landing position on the recording medium M easily shifts.

### Termination Waveform WB

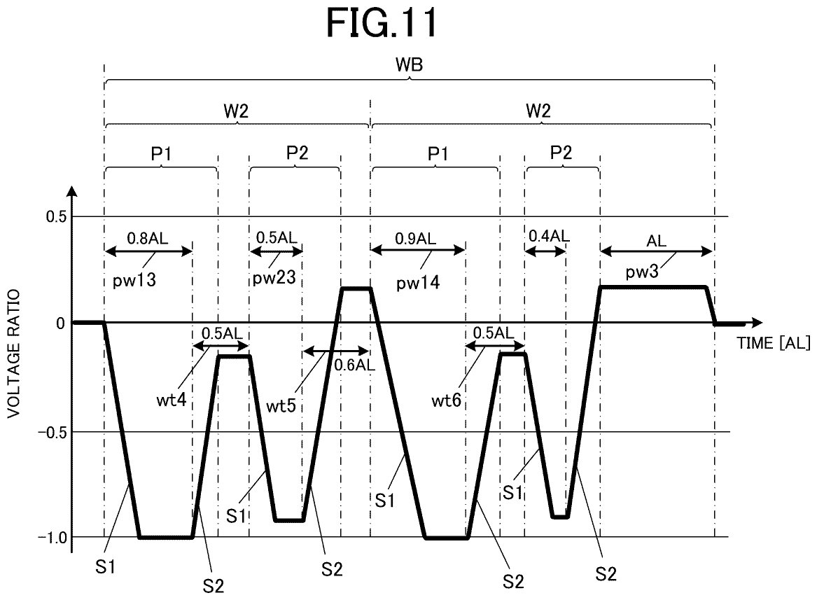

FIG. 11 is an enlarged view of the termination waveform WB.

Similarly to the first unit drive waveform W1, each of the two second unit drive waveforms W2 included in the termination waveform WB includes the main pulse P1 and the pullback pulse P2. Each of the main pulse P1 and the pullback pulse P2 of the second unit drive waveform W2 also include the inflation portion S1 and the deflation portion S2. Also in the second unit drive waveform W2, one ink droplet is ejected from the nozzle N by a combination of the main pulse P1 and the pullback pulse P2.

The pulse width of the main pulse P1 in the second unit drive waveform W2 is also set, similarly to the first unit drive waveform W1, within a range of 0.7 AL or more and 1 AL or less, more preferably 0.7 AL or more and 0.9 AL or less. Furthermore, the pulse width of the main pulse P1 in the second unit drive waveform W2 is determined to be equal to or greater than the pulse width of the main pulse P1 in the first unit drive waveform W1. According to the present embodiment, the pulse width pw13 of the main pulse P1 in the first second unit drive waveform W2 is 0.8 AL. Further, the pulse width pw14 of the main pulse P1 in the second second unit drive waveform W2 is 0.9 AL.

Note that the pulse width of the main pulse P1 in each second unit drive waveform W2 may be greater than any of the pulse widths of the main pulses P1 in the first unit drive waveforms W1.

Further, the pulse width pw23 of the pullback pulse P2 in the first second unit drive waveform W2 is 0.5 AL. Further, the pulse width pw24 of the pullback pulse P2 in the second second unit drive waveform W2 is 0.4 AL.

The standby time wt4 between the pulse width pw13 and the pulse width pw23 is 0.5 AL. The standby time wt5 between the pulse width pw23 and the pulse width pw14 is 0.6 AL. The standby time wt6 between the pulse width pw 14 and the pulse width pw24 is 0.5 AL. Each of the standby times wt4 to wt6 in the termination waveform WB is longer than any of the standby times wt1 to wt3 in the repetitive waveform WA.

As shown in FIG. 6, the voltage amplitude Δ V2 of the deflation portion S2 of the pullback pulse P2 in the second unit drive waveform W2 is larger than the voltage amplitude Δ V1 of the deflation portion S2 of the pullback pulse P2 in the first unit drive waveform W1. To be specific, while Δ V1 is 0.73, Δ V2 is 1.1.

In order to secure such voltage amplitude Δ V2, in the second unit drive waveform W2, a part of the pullback pulse P2 is higher than the reference potential. In detail, the deflation portion S2 of the pullback pulse P2 is displaced to the potential exceeding the reference potential.

Increasing the voltage amplitude Δ V2 in this manner causes the ink ejected in response to the main pulse P1 to be accelerated significantly by the contraction of the pressure chamber 131 in accordance with the deflation portion S2 of the pullback pulse P2. Therefore, it is possible to increase the speed of the ink droplet ejected by the second unit drive waveform W2. As a result, the ink ejected by the second unit drive waveform W2 tends to catch up with the droplet of the ink ejected earlier by the first unit drive waveform W1. The voltage amplitude Δ V2 is set to a magnitude at which the six ink droplets are combined within 35 microseconds after the end of the application of the second unit drive waveform W2. The speed of the ink droplet ejected by the second unit drive waveform W2 is, for example, about 7 m/sec.

After the end of the application of the last pullback pulse P2 included in the termination waveform WB, a cancellation waveform having a potential higher than the reference potential is applied. The length of the pulse width pw3 of the cancellation waveform is AL. By applying such cancellation waveform after the pullback pulse P2, it is possible to cancel the pressure vibration in the nozzle N oscillating in the AL cycle. Accordingly, it is possible to suppress the pressure vibration in the nozzle N at the time of applying the next composite drive waveform WF and to discharge the droplet of the ink with an appropriate amount and speed.

### EXAMPLE

Next, an experiment conducted to confirm the effect of the driving method of the above embodiment will be described.

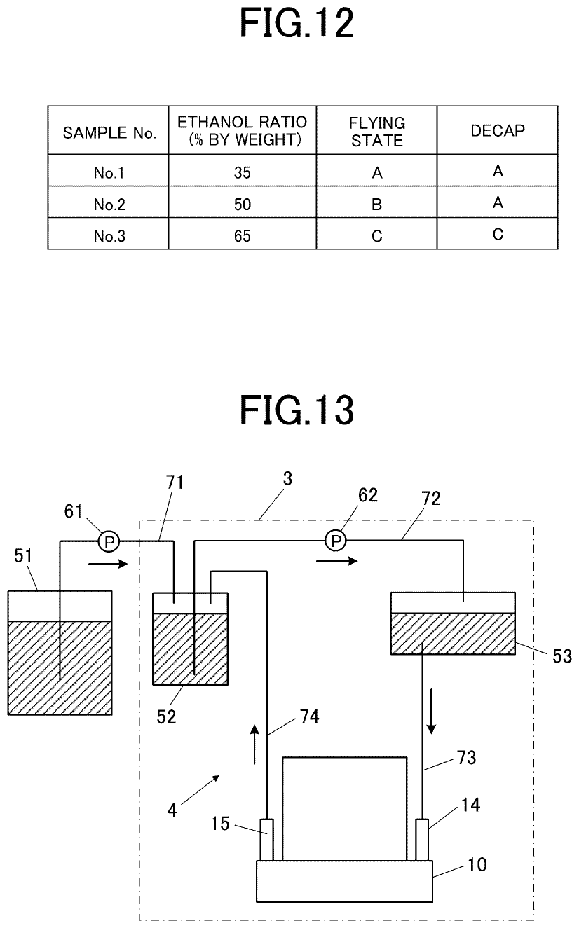

FIG. 12 is a view illustrating details and results of an experiment.

In the experiment, the ink including the solvent containing ethanol was used. The ink was ejected from the nozzle N of the inkjet head 10 by the above-described composite drive waveform WF. Then, a flying state of the ejected ink and a degree of decap of the nozzle N were evaluated.

In addition, the experiment was performed using three ink samples (No. 1 to No. 3) having different ethanol content percentages (wt %). The content percentage of ethanol in the entire ink was 35% by mass in sample No. 1, 50% by mass in sample No. 2, and 65% by mass in sample No. 3.

The flying state was evaluated in three stages of “A” to “C”. Specifically, a case in which no disturbance was detected in the flying direction and speed of the ink droplet was evaluated as “A”. In addition, a case in which the disturbance was detected in the flying direction and/or speed of the ink droplets from some of the nozzles N within the range of acceptable image quality was evaluated as “B”. In addition, a case in which an unacceptable deterioration in image quality occurred as a result of detecting the disturbance in the flying direction and/or speed of ink droplets from a large number of nozzles N was evaluated as “C”.

The decap was evaluated on a scale of three stages “A” to “C”. Specifically, a case in which the decap did not occur and the ink droplet was appropriately ejected from each nozzle N was evaluated as “A”. In addition, a case in which the ink is not ejected due to the decap occurring in some of the nozzles N within the range of acceptable image quality was evaluated as “B”. In addition, a case in which unallowable deterioration in the image quality occurred as a result of the ink not being ejected due to the decap occurring in a large number of nozzles N was evaluated as “C”.

As a result of the experiment, the sample No. 1 having an ethanol ratio of 35% by mass had “A” as the evaluation results of both the flying state and the decap. This is because the ink in the nozzle N is effectively stirred by the four pulse waveforms within 4 AL from the head, and as a result, the destabilization of the meniscus and the occurrence of the decap are suppressed. Another reason is that the two high-speed droplets were ejected after the four low-speed droplets were ejected, and thus the six droplets appropriately combined and landed without separation.

In addition, the sample No. 2 in which the ethanol ratio was 50% by mass had the evaluation result “B” for the flying state and the evaluation result “A” for the decap. The ink of the sample No. 2 has a higher ethanol ratio than the sample No. 1. For this reason, the ink is easily dried in the nozzle N, and the ink is easily solidified so as to close a part of the opening Na. Due to this influence, the flying state was likely to be slightly disturbed, and the evaluation result was “B”, but acceptable image quality was obtained.

On the other hand, the sample No. 3 in which the ethanol ratio is 65% by mass has the evaluation results of “C” in both the flying state and the decap. This is because the ink is extremely easy to dry in the nozzle N due to the ethanol ratio being excessively high.

The following is derived from the experimental results of FIG. 12. The ink can be ejected in the appropriate flying state by setting the content percentage of ethanol in the entire ink to be 50% by mass or less and using the above-described composite drive waveform WF. Furthermore, by setting the content percentage of ethanol in the entire ink to 35% by mass or less and using the above-described composite drive waveform WF, it is possible to discharge the ink in a more appropriate flying state.

Note that when the alcohol other than ethanol was used among alcohols having the carbon number of 1 or more and 4 or less, results similar to those in FIG. 12 were obtained.

### Modification Example 1

Next, modification example 1 of the present embodiment will be described.

The composite drive waveform WF according to the present embodiment includes four pulse waveforms within 4 AL from the start of the application of the first pulse waveform, but instead of this, may include five or more pulse waveforms within 4 AL from the start of the application of the first pulse waveform. For example, three first unit drive waveforms W1 may be included in the first repetitive waveform WA having the length 4 AL, and three droplets may be discharged by the repetitive waveform WA. In this manner, the application period of six pulse waveforms, i.e., three main pulses P1 and three pullback pulses P2, is included within 4 AL from the start of application of the first pulse waveform. According to this, it is possible to effectively stir the ink in the nozzle N by oscillating the meniscus of the nozzle N at a higher frequency. For this reason, it is possible to more effectively suppress the destabilization and the decap of the meniscus.

### Modification Example 2

Next, modification example 2 of the embodiment will be described. Modification example 2 may be combined with modification example 1.

Hereinafter, the content percentage of the alcohol having the carbon number 1 or more and 4 or less in the entire ink is referred to as “content percentage R (% by weight)”. Further, the number of pulse waveforms applied within 4 AL from the start of application of the first pulse waveform is referred to as “pulse number PN”. In the present modification example, the drive waveform pattern of the composite drive waveform WF is determined such that the pulse number PN increases as the content percentage R increases.

The greater the content percentage R, the more likely the ink is to dry in the nozzle N. In addition, as the pulse number PN increases, the vibration frequency of the meniscus of the nozzle N increases, and a drying suppression effect of the ink increases. Therefore, according to the driving method of the present modification example, it is possible to increase the drying suppression effect of the ink in a case in which the ink is easily dried in the nozzle N. Therefore, it is possible to appropriately suppress destabilization or the decap of the meniscus in accordance with the composition of the quick-drying ink.

### Modification Example 3

Next, modification example 3 of the embodiment described above will be described. Modification example 3 may be combined with modification example 1 and/or modification example 2.

The voltage amplitude ΔV1 in the first unit drive waveform W1 and the voltage amplitude ΔV2 in the second unit drive waveform W2 shown in FIG. 6 may be adjusted according to the ink.

For example, the ratio (Δ V2/Δ V1) of the voltage amplitude Δ V2 to the voltage amplitude Δ V1 may be adjusted to be higher as the content percentage R becomes higher. Thus, the speed of the ink to be ejected later by the second unit drive waveform W2 can be made higher for the ink whose meniscus is more likely to become unstable due to drying in the nozzle N. Therefore, it is possible to appropriately suppress the occurrence of a defect in which a plurality of droplets land in a separation state in accordance with the composition of the quick-drying ink.

### Modification Example 4

Next, modification example 4 of the embodiment described above will be described. Modification example 4 may be combined with some or all of modification example 1 to 3.

The inkjet head 10 according to modification example 4 is connected to the circulation channel 4 passing through the inkjet head 10. During the ejection of the ink by the composite drive waveform WF, the ink not ejected from the nozzle N circulates in the circulation channel 4.

FIG. 13 is a diagram illustrating the circulation channel 4 of the ink in the head unit 3 according to modification example 4.

In FIG. 13, one head unit 3 and the head unit 51 connected to the head unit 3 are illustrated. The head unit 3 includes a first sub-tank 52, a second channel section 72, a liquid feed pump 62, a second sub-tank 53, a third channel section 73, the inkjet head 10, and a fourth channel section 74. The first sub-tank 52, the second channel section 72, the second sub-tank 53, the inkjet head 10, and the fourth channel section 74 form the circulation channel 4.

The main tank 51 stores the ink to be supplied to the head unit 3. The ink in the main tank 51 is fed to the first sub-tank 52 in the head unit 3 via the first channel section 71 by operation of the liquid feed pump 61. The first sub-tank 52 herein is an ink tank having a smaller capacity than the main tank 51. The first sub-tank 52 stores the ink supplied from the main tank 51. Furthermore, the first sub-tank 52 stores the ink that has been refluxed from the outlet 15 of the inkjet head 10 via the fourth channel section 74.

The liquid feed pump 62 is provided in the second channel section 72 and feeds the ink from the first sub-tank 52 to the second sub-tank 53 via the second channel section 72. The second sub-tank 53 stores the ink sent from the first sub-tank 52. A water head difference between the second sub-tank 53 and the inkjet head 10 prevents the ink from leaking from the nozzle N while the ink is not ejected.

The inkjet head 10 includes an inlet 14 connected to the third channel section 73 and an outlet 15 connected to the fourth channel section 74. The ink supplied from the second sub-tank 53 to the inlet 14 through the second channel 73 is supplied to the nozzle N via the common channel 121. In addition, the ink which is not ejected from the nozzle N is guided to the outlet 15 via the common channel 121. The ink flowing out of the outlet 15 returns to the first sub-tank 52 through the fourth channel section 74.

Note that the ink circulation channel 4 of the other head units 3 are the same as those in FIG. 13.

### Effect

As described above, in the method of driving the inkjet head 10 according to the present embodiment, the voltage signal having the composite drive waveform WF including a plurality of unit drive waveforms is applied to the piezoelectric element 13. Thus, a plurality of ink droplets that land on the recording medium M in the combined state are ejected from the nozzle N. Further, the composite drive waveform WF includes at least four pulse waveforms within 4 AL from the start of the application of the first pulse waveform. The composite drive waveform WF includes the first unit drive waveform W1 and the second unit drive waveform W2 that is applied at the end of the composite drive waveform WF and that causes the ink droplet to be ejected at a higher speed than the first unit drive waveform W1. The ink contains the alcohol having the carbon number of 1 or more and 4 or less in a range of 20% by mass or more and 50% by mass or less relative to the entire ink.

According to this driving method, by applying at least four pulse waveforms within 4 AL, the meniscus of the nozzle N oscillates at a high frequency, and the ink in the nozzle N is stirred. Therefore, even when the quick-drying ink is used, drying of the ink in the nozzle N can be suppressed. Therefore, since the destabilization of the meniscus and the occurrence of the decap are effectively suppressed, it is possible to suppress the deviation of the flying direction and the speed of the ink. Accordingly, it is possible to suppress the deviation of the landing position of the ink. In addition, it is possible to suppress the occurrence of the defect in which a plurality of droplets land in a state of not being combined. As a result, in a case in which the quick-drying ink is used, it is possible to effectively suppress deterioration in image quality. Therefore, it is possible to continuously operate for a long time while maintaining the image quality within an allowable range.

Furthermore, the ink may contain the alcohol in a range of 20% by mass or more and 35% by mass or less with respect to the entire ink. Thus, ease of drying can be suppressed while practically sufficient quick-drying properties are ensured. Therefore, it is possible to cause the ink to be ejected in a more appropriate flying state.

In addition, the ink may have a viscosity of 6 cP or less at the time of being discharged from the nozzle N. By lowering the viscosity of the ink in this way, the meniscus can be smoothly renewed, and the decap can be made less likely to occur.

In addition, the maximum width of the opening Na of the nozzle N may be 23 μm or less. As a result, it is possible to make the area of the meniscus small and to make it more difficult for the decap to occur.

The inkjet head 10 further includes the nozzle substrate 110 having the nozzle N. The nozzle N penetrates the nozzle substrate 110 and has the tapered part. An opening area of the tapered part in the cross section perpendicular to the ink ejection direction gradually increases from a side of the opening Na from which ink droplets are ejected toward the opposite side of the opening. In the cross section that passes the center of the opening Na and is parallel to the ejection direction, the maximum value of the inclination angle of the surface of the tapered part from the ejection direction is 40° or more. Accordingly, it is possible to reduce the distance by which the meniscus is drawn into the far part of the nozzle N in the ejection direction. By reducing the movement distance of the meniscus in this way, the meniscus can be maintained in a state where the area of the meniscus is small when the meniscus is pulled in. Therefore, it is possible to make the decap less likely to occur.

In addition, the voltage signal of the vibration waveform W0 for vibrating the liquid surface of the ink in the nozzle N may be applied to the piezoelectric element 13 in a period in which the droplets of the ink are not ejected from the nozzle N. Accordingly, it is possible to suppress the drying of the ink in the nozzle N when the ink is not ejected.

The composite drive waveform WF may be applied to the piezoelectric element 13 at frequencies higher than or equal to 10 kHz. Thus, since the printing interval, that is, the interval between the composite drive waveforms WF can be shortened, the occurrence of the decap can be more effectively suppressed.

Furthermore, the voltage amplitude of the pulse waveform included in the second unit drive waveform W2 is set to such a magnitude that a plurality of ink droplets are combined within 35 microseconds after the end of the application of the second unit drive waveform W2. Thus, it is possible to more reliably suppress the occurrence of a problem in which a plurality of droplets land in a non-combined state. In addition, the flying direction of the ink can be made less likely to be curved.

In addition, by varying the number of unit drive waveforms included in the composite drive waveform WF, the droplet amount of the ink after combining can be adjusted to any one of a plurality of different droplet amounts. Further, the minimum droplet amount among the plurality of droplet amounts may be 5 pl or less. As a result, the droplet amount of ink can be easily adjusted. In addition, fine dots can be formed by the landed ink.

In addition, the inkjet head 10 may be connected to the circulation channel 4 passing through the inkjet head 10. The ink that has not been ejected from the nozzle N during ejection of the ink with the composite drive waveform WF may be circulated in the circulation channel 4. By circulating the ink in this way, it is possible to discharge air bubbles and foreign substances mixed in the ink of the inkjet head 10 from the inkjet head 10.

The inkjet recording apparatus 1 according to the present embodiment includes the inkjet head 10 and the head drive controller 20 that controls the voltage signal to be applied to the piezoelectric element 13. The head drive controller 20 applies, to the piezoelectric element 13, the voltage signal of the composite drive waveform WF including a plurality of unit drive waveforms. Thus, a plurality of ink droplets that land on the recording medium M in the combined state are ejected from the nozzle N. Further, the composite drive waveform WF includes at least four pulse waveforms within 4 AL from the start of the application of the first pulse waveform. The composite drive waveform WF includes the first unit drive waveform W1 and the second unit drive waveform W2 that is applied at the end of the composite drive waveform WF and that causes the ink droplet to be ejected at a higher speed than the first unit drive waveform W1. The ink contains the alcohol having the carbon number of 1 or more and 4 or less in a range of 20% by mass or more and 50% by mass or less relative to the entire ink. In this way, in a case in which the quick-drying ink is used, it is possible to effectively suppress deterioration in image quality.

### Others

Note that the present invention is not limited to the above embodiment, and various modifications are possible.

For example, the number of repetitive waveforms WA is not limited to two, and may be one or three or more in accordance with the number of droplets of ink to be ejected and combined.

In addition, each of the plurality of continuous repetitive waveforms WA is not necessarily completely the same, and may have a shape slightly different from each other.

The number of the second unit drive waveforms W2 included in the termination waveform WB is not limited to two, and may be one or three or more.

Furthermore, although the above embodiment is described with the example in which a part of the second unit drive waveform W2 is higher than the reference potential, it is not limited thereto. For example, the voltage amplitude Δ V2 of the second unit drive waveform W2 may be adjusted to be larger than the voltage amplitude Δ V1 of the first unit drive waveform W1 after the entire composite drive waveform WF is set to be equal to or lower than the reference potential.

Furthermore, although the inkjet head 10 in a vent mode in which the ink is ejected by deforming the piezoelectric element 13 to change the pressure of ink in the pressure chamber 131 has been described as an example in the above embodiment, this is not intended to be limiting. For example, the present invention may be applied to the shear mode inkjet head in which the pressure chamber is provided inside the piezoelectric material and shear mode-type displacement is caused in the piezoelectric material on a wall surface of the pressure chamber to change the pressure on the ink in the pressure chamber.

Furthermore, although the inkjet recording apparatus 1 of the single-pass type has been described as an example in the embodiment described above, the present invention may be applied to the inkjet recording apparatus that records the image while scanning the inkjet head 10.

Although several embodiments of the present invention have been described, the scope of the present invention is not limited to the above-described embodiments, but encompasses the scope of the invention described in the claims and equivalents thereof.

### INDUSTRIAL APPLICABILITY

The present invention can be used for an inkjet head driving method and an inkjet recording apparatus.

### REFERENCE SIGNS LIST

1 inkjet recording apparatus
2 conveyance section
3 head unit
4 circulation channel
10 inkjet head
11 head chip
12 ejection selection switching element
13 piezoelectric element
14 inlet
15 outlet
20 head drive controller (drive controller)
30 main body controller
110 nozzle substrate
120 channel substrate
130 element substrate
131 pressure chamber
133 vibration plate
135 piezoelectric material layer
136 electrode layer
d diameter
m meniscus
M recording medium
N nozzle
Na opening
P1 main pulse (first pulse waveform)
P2 pullback pulse (second pulse waveform)
R1 piezoelectric functional region
S1 inflation portion
S2 deflation portion
W0 vibration waveform
W1 first unit drive waveform
W2 second unit drive waveform
WA repetitive waveform
WB termination waveform
WF composite drive waveform

1. An inkjet head driving method used in an inkjet head configured to be capable of ejecting ink droplets from a nozzle in which change in pressure is applied to ink in a pressure chamber by deforming a piezoelectric element according to an application of a voltage signal of a unit drive waveform including one or more pulse waveforms, the inkjet head driving method comprising:
applying, to the piezoelectric element, the voltage signal of a composite drive waveform including a plurality of the unit drive waveforms to eject from the nozzle a plurality of the ink droplets landing on a recording medium in a combined state,
wherein,
the composite drive waveform includes at least four pulse waveforms within 4 AL from a start of applying the first pulse waveform,
the composite drive waveform includes a first unit drive waveform and a second unit drive waveform that is applied at the end of the composite drive waveform and that causes the ink droplet to be ejected at a higher speed than the first unit drive waveform, and
the ink contains an alcohol having a carbon number of 1 or more and 4 or less in a range of 20% by mass or more and 50% by mass or less relative to an entirety of the ink.

2. The inkjet head driving method according to claim 1, wherein the ink contains the alcohol within a range of 20% by mass or more and 35% by mass or less relative to the entirety of the ink.

3. The inkjet head driving method according to claim 1, wherein the ink has a viscosity of 6 cP or less at the time of being ejected from the nozzle.

4. The inkjet head driving method according to claim 1, wherein a maximum width of an opening of the nozzle is 23 μm or less.

5. The inkjet head driving method according to claim 1,
wherein,
the inkjet head includes a nozzle substrate including the nozzle,
the nozzle includes a tapered part which penetrates the nozzle substrate and in which an opening area in a cross section orthogonal to an ink ejection direction gradually increases from an opening side from which the ink droplet is ejected toward a side opposite to the opening, and
in a cross section that passes a center of the opening and is parallel to the ejection direction, a maximum value of an inclination angle of a surface of the tapered part from the ejection direction is 40° or more.

6. The inkjet head driving method according to claim 1, wherein a voltage signal of a vibration waveform for vibrating a liquid surface of the ink in the nozzle is applied to the piezoelectric element in a period in which the ink droplet is not discharged from the nozzle.

7. The inkjet head driving method according to claim 1, wherein the composite drive waveform is applied to the piezoelectric element at a frequency greater than or equal to 10 kHz.

8. The inkjet head driving method according to claim 1, wherein a voltage amplitude of a pulse waveform included in the second unit drive waveform is set to a magnitude with which the plurality of ink droplets are combined within 35 microseconds after the end of the application of the second unit drive waveform.

9. The inkjet head driving method according to claim 1, wherein,
by varying the number of the unit drive waveforms included in the composite drive waveform, a droplet amount of the ink after combining can be adjusted to any one of a plurality of different droplet amounts, and
a minimum droplet amount among the plurality of the droplet amounts is 5 pl or less.

10. The inkjet head driving method according to claim 1, wherein,
the inkjet head is connected to a circulation channel that passes the inkjet head, and
the ink that is not ejected from the nozzle during the ejection of the ink by the composite drive waveform is circulated in the circulation channel.

11. An inkjet recording apparatus comprising:
an inkjet head configured to be capable of ejecting ink droplets from a nozzle in which change in pressure is applied to ink in a pressure chamber by deforming a piezoelectric element according to an application of a voltage signal of a unit drive waveform including one or more pulse waveforms; and
a drive controller that controls a voltage signal applied to the piezoelectric element,
wherein,
the drive controller applies to the piezoelectric element, a voltage signal of a composite drive waveform including a plurality of the unit drive waveforms to eject from the nozzle a plurality of the ink droplets landing on a recording medium in a combined state,
the composite drive waveform includes at least four pulse waveforms within 4 AL from a start of applying the first pulse waveform,
the composite drive waveform includes a first unit drive waveform and a second unit drive waveform that is applied at the end of the composite drive waveform and that causes the ink droplet to be ejected at a higher speed than the first unit drive waveform, and
the ink contains an alcohol having a carbon number of 1 or more and 4 or less in a range of 20% by mass or more and 50% by mass or less relative to an entirety of the ink.
